(19) United States
(12) Patent Application Publication
(10) Pub. No.: US 2014/0339210 A1
(43) Pub. Date: Nov. 20, 2014

(54) DIRECT RESISTANCE HEATING APPARATUS AND DIRECT RESISTANCE HEATING METHOD

(71) Applicant: NETUREN CO., LTD., Tokyo (JP)

(72) Inventors: Kunihiro Kobayashi, Tokyo (JP); Hironori Ooyama, Tokyo (JP); Tokio Sekigawa, Tokyo (JP)

(21) Appl. No.: 14/361,641

(22) PCT Filed: Nov. 29, 2012
(86) PCT No.: PCT/JP2012/081588

§ 371 Date: May 29, 2014

(30) Foreign Application Priority Data
Nov. 29, 2011 (JP) 2011-261076
Nov. 29, 2011 (JP) 2011-261077

(51) Int. Cl. H05B 3/00; H05B 3/02

(52) U.S. Cl. CPC H05B 3/0004; H05B 3/023
USPC 219/162; 219/50

(57) ABSTRACT

A direct resistance heating apparatus includes a first electrode and a second electrode, and a moving mechanism configured to move at least one of the first electrode and the second electrode. A direct resistance heating method includes steps of providing a workpiece having a heating target region, a resistance of which per unit length in one direction thereof varying along the one direction, placing a first electrode and a second electrode on the heating target region, and moving at least one of the first electrode and the second electrode such that a time during which the electric current is applied to each part of the heating target region is adjusted in accordance with a change of the resistance per unit length, thereby heating the workpiece such that the each part of the heating target region is heated to a temperature within a target temperature range.

### TECHNICAL FIELD

The present invention relates to a direct resistance heating apparatus and a direct resistance heating method in which an electric current is applied to a workpiece such as a steel blank.

### BACKGROUND ART

Heat treatment is applied to, for example, vehicle structures such as a center pillar and a reinforcement to ensure strength. Heat treatment can be classified into two types, namely, indirect heating and direct heating. An example of indirect heating is a furnace heating in which a workpiece is placed inside a furnace and the temperature of the furnace is controlled to heat the workpiece. Examples of direct heating include induction heating in which an eddy current is applied to a workpiece to heat the workpiece, and a direct resistance heating (also called as a direct electric conduction heating) in which an electric current is applied directly to a workpiece to heat the workpiece.

According to a first related art, a metal blank is heated by induction heating or direct resistance heating prior to being subjected to plastic working by working means. For example, the heating means having electrode rollers or an induction coil is disposed upstream of the working means having a cutter machine, and the metal blank is heated while continuously being conveyed (see, e.g., JP06-079389A).

According to a second related art, to heat a steel plate having a substantially constant width along the longitudinal direction of the steel plate by direct resistance heating, electrodes are arranged on respective end portions of the steel plate in the longitudinal direction, and a voltage is applied between the electrodes. In this case, because an electric current flows uniformly through the steel plate, an amount of heat generation is uniform over the entire steel plate. On the other hand, to heat a steel plate having a varying width along the longitudinal direction of the steel plate, a set of multiple electrodes are disposed side by side on one side of the steel plate in the widthwise direction, and another set of multiple electrodes are disposed side by side on the other side of the steel plate in the widthwise direction, such that the electrodes disposed on respective sides of the steel plate in the widthwise direction form multiple pairs of electrodes. In this case, an equal electric current is applied between each of the pair of electrodes, so that the steel plate is heated to a uniform temperature (see, e.g., JP3587501B2).

According to a third related art, a first electrode is fixed to one end of a steel rod, and a clamping-type second electrode is provided to hold the boundary between a portion of the steel rod to be heated and a portion of the steel rod to be non-heated, so that the steel rod is partially heated (see, e.g., JP53-007517A).

When heating a workpiece, in particular, a workpiece having a varying width along the longitudinal direction of the workpiece, it is preferable that an amount of heat applied per unit volume is the same over the entire workpiece, like in the furnace heating. However, a heating furnace requires large-scale equipment, and a temperature control of the furnace is difficult.

Accordingly, in terms of production cost, direct resistance heating is preferable. However, when a plurality of pairs of electrodes is provided like in the second related art, an amount of electric current to be applied is controlled for each of the pairs of electrodes, which increases installation cost. Further, arrangement of a plurality of pairs of electrodes with respect to one workpiece reduces productivity.

### SUMMARY OF INVENTION

It is an object of the present invention to provide a direct resistance heating apparatus and a direct resistance heating method requiring less number of electrodes for uniformly heating a workpiece or heating a workpiece to have a desired temperature distribution.

According to an aspect of the present invention, a direct resistance heating apparatus includes a pair of electrodes adapted to be electrically coupled to a power supply unit and having a first electrode and a second electrode, and a moving mechanism configured to move at least one of the first electrode and the second electrode to change a distance between the first electrode and the second electrode with the first electrode and the second electrode both contacting a workpiece and with an electric current being applied from the power supply unit to the workpiece through the pair of electrodes.

Each of the first electrode and the second electrode may have a length extending across a heating target region of the workpiece.

The moving mechanism may include an adjusting unit configured to control a moving speed of the at least one of the first electrode and the second electrode, and a drive mechanism configured to move the at least one of the first electrode and the second electrode in accordance with the adjusting unit.

The adjusting unit may be configured to obtain the moving speed based on shape and size data of the workpiece, so that the drive mechanism moves the at least one of the first electrode and the second electrode at the moving speed obtained by the adjusting unit.

Each of the first electrode and the second electrode may include a main electrode portion, an auxiliary electrode portion, and a lead portion connected to the power supply unit to apply the electric current to the main electrode portion. The main electrode portion and the auxiliary electrode portion may be arranged to hold the workpiece from above and below the workpiece.

The moving mechanism may be configured to move only one of the first electrode and the second electrode. Alternatively, the moving mechanism may be configured to move both of the first electrode and the second electrode.

The at least one of the first electrode and the second electrode may be configured to roll or to slide on the heating target region of the workpiece while contacting the heating target region.

According to another aspect of the present invention, a direct resistance heating method includes steps of providing a workpiece having a heating target region, a resistance of which per unit length in one direction thereof varying along the one direction, placing a first electrode and a second electrode such that a space is provided between the first electrode and the second electrode and such that each of the first electrode and the second electrode extends across the heating target region, and moving at least one of the first electrode and the second electrode with an electric current being applied to the heating target region such that a time during which the electric current is applied to each part of the heating target region is adjusted in accordance with a change of the resistance per unit length, thereby heating the workpiece such that the each part of the heating target region is heated to a temperature within a target temperature range.

The electric current applied from a power supply unit to the first electrode and the second electrode may be constant.

The heating target region of the workpiece may be configured such that a cross-sectional area of the heating target region is reduced in the one direction, and the at least one of the first electrode and the second electrode is moved in accordance with a reduction of the cross-sectional area.

According to one or more aspects of the present invention, when the heating target region of the workpiece is virtually divided into a plurality of sub-regions along the electrode moving direction in a stripe pattern, it is possible to reduce the amount of heat to be applied to the respective sub-regions along the electrode moving direction.

Accordingly, first, in a case where the resistance per unit length along one direction of the heating target region of the workpiece changes along the longitudinal direction, for example, a cross-sectional area increases or decreases along the one direction, the first electrode and the second electrode may be disposed on both sides in the longitudinal direction, and in a state in which electricity is being applied, at least one electrode is moved in a direction in which the resistance per unit length along the one direction decreases. Further, in accordance with the decrease in the resistance per unit length along the one direction, the electrode moving speed is adjusted. Therefore, the amount of electricity in each of the sub-regions, into which the heating target region is virtually divided in a stripe pattern along the movement direction, do not depend on the location of the sub-region and falls within the same range. As a result, even in a case where the resistance per unit length along one direction changes, it is possible to equalize the amounts of heat to be applied to the sub-regions and to heat the heating target region almost uniformly without arranging a plurality of pairs of electrodes.

Second, in a case where a heating target region of a workpiece is heated by direct resistance heating to have a different temperature distribution, for example, in a case where a heating target region has a substantially constant cross-sectional area and is heated by direct resistance heating to have a temperature distribution in which the temperature decreases from a high temperature to a low temperature in one direction, at least one electrode is moved in the one direction, whereby the amount of electricity in the respective sub-regions, into which the heating target region is virtually divided in a stripe pattern along the movement direction, are made different depending on the location of the sub-regions, thereby enabling to heat the workpiece with a desired temperature distribution.

### BRIEF DESCRIPTION OF DRAWINGS

FIG. 1A is a plan view of a direct resistance heating apparatus according to a first embodiment of the present invention, illustrating a state before electric conduction;

FIG. 1B is a front view of the direct resistance heating apparatus of FIG. 1A, illustrating the state before electric conduction;

FIG. 1C is a plan view of the direct resistance heating apparatus of FIG. 1A, illustrating a state after electric conduction;

FIG. 1D is a front view illustrating the direct resistance heating apparatus of FIG. 1A, illustrating the state after electric conduction;

FIG. 2 is a diagram for explaining a relational expression related to direct electric conduction;

FIG. 3 is a front view of an example of a detailed configuration of the direct resistance heating apparatus of FIGS. 1A to 1D;

FIG. 4 is a left side view of the detailed configuration of the direct resistance heating apparatus of FIG. 3;

FIG. 5 is a plan view of a portion of the detailed configuration of the direct resistance heating apparatus of FIG. 3;

FIG. 6 is a right side view of the detailed configuration of the direct resistance heating apparatus of FIG. 3;

FIG. 7A is a plan view of a direct resistance heating apparatus according to a second embodiment of the present invention, illustrating a state before electric conduction;

FIG. 7B is a front view of the direct resistance heating apparatus of FIG. 7A, illustrating the state before electric conduction;

FIG. 7C is a plan view of the direct resistance heating apparatus of FIG. 7A, illustrating a state after electric conduction;

FIG. 7D is a front view of the direct resistance heating apparatus of FIG. 7A, illustrating the state after electric conduction;

FIG. 8A is a plan view of a direct resistance heating apparatus according to a third embodiment of the present invention, and shows a state before electric conduction;

FIG. 8B is a front view of the direct resistance heating apparatus of FIG. 8A, illustrating the state before electric conduction;

FIG. 8C is a plan view of the direct resistance heating apparatus of FIG. 8A, illustrating a state when electricity is being applied;

FIG. 8D is a front view of the direct resistance heating apparatus of FIG. 8A, illustrating the state when electricity is being applied;

FIG. 8E is a plan view of the direct resistance heating apparatus of FIG. 8A, illustrating a state after electric conduction;

FIG. 8F is a front view of the direct resistance heating apparatus of FIG. 8A, illustrating the state after electric conduction;

FIG. 9A is a plan view of a direct resistance heating apparatus according to a fourth embodiment of the present invention, and shows a state before electric conduction;

FIG. 9B is a front view of the direct resistance heating apparatus of FIG. 9A, illustrating the state before electric conduction;

FIG. 9C is a plan view of the direct resistance heating apparatus of FIG. 9A, illustrating a state after electric conduction;

FIG. 9D is a front view of the direct resistance heating apparatus of FIG. 9A, illustrating the state after electric conduction;

FIG. 10A is a plan view of a direct resistance heating apparatus according to a fifth embodiment of the present invention, illustrating a state before electric conduction;

FIG. 10B is a front view of the direct resistance heating apparatus of FIG. 10A, illustrating the state before electric conduction;

FIG. 10C is a plan view of the direct resistance heating apparatus of FIG. 10A, illustrating a state after electric conduction;

FIG. 10D is a front view of the direct resistance heating apparatus of FIG. 10A, illustrating the state after electric conduction;

FIG. 11A is a plan view of a direct resistance heating apparatus according to a sixth embodiment of the present invention, illustrating a state before electric conduction;

FIG. 11B is a front view of the direct resistance heating apparatus of FIG. 11A, illustrating the state before electric conduction;

FIG. 11C is a plan view of the direct resistance heating apparatus of FIG. 11A, illustrating a state after electric conduction; and

FIG. 11D is a front view of the direct resistance heating apparatus of FIG. 11A, illustrating the state after electric conduction.

### DESCRIPTION OF EMBODIMENTS

Hereinafter, embodiments of the present invention will be described in detail with reference to the drawings. A direct resistance heating apparatus and a direct resistance heating method according to one or more embodiments of the present invention can be applied, not only to a workpiece having a uniform thickness and a constant width along the longitudinal direction of the workpiece, but also to a workpiece having a region of the workpiece to be heated (hereinafter, “heating target region”) whose width and/or thickness changes along the longitudinal direction of the heating target region so that the cross-sectional area of the heating target region is reduced along the longitudinal direction of the heating target region, and also to a workpiece having a heating target region formed with an opening or notch so that a cross-sectional area of the heating target region is reduced along the longitudinal direction of the heating target region. The workpiece is, for example, a steel blank which can be heated by applying an electric current. The workpiece may be a single member, or may include a plurality of members having different resistivities and formed in a one-piece structure by welding or the like. Further, a workpiece may include not only one but more than one heating target regions. When the workpiece has more than one heating target regions, the heating target regions may be contiguous or be separated.

### First Embodiment

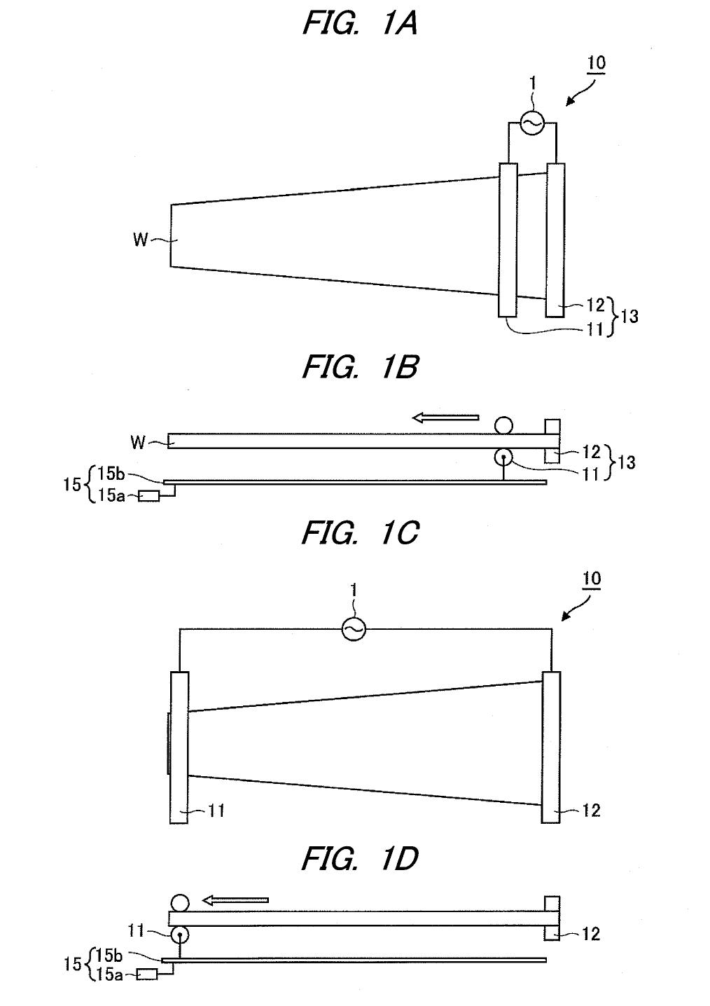

A direct resistance heating apparatus 10 according to a first embodiment of the present invention will be described with reference to FIGS. 1A to 1D.

The direct resistance heating apparatus 10 includes a pair of electrodes 13 electrically coupled to a power supply unit 1 and having a first electrode 11 and a second electrode 12, and a moving mechanism 15 configured to move at least one of the first electrode 11 and the second electrode 12.

In this example, with the first electrode 11 and the second electrode 12 both contacting a workpiece w and an electric current being applied from power supply unit 1 to the workpiece w through the pair of electrodes 13, the moving mechanism 15 moves the first electrode 11, to change a distance between the first electrode 11 and the second electrode 12.

That is, the first electrode 11 is a moving electrode which is moved by the moving mechanism 15, and the second electrode 12 is a fixed electrode just contacting the workpiece w. In another example, the second electrode 12 may be configured as a moving electrode and the first electrode 11 may be configured as a fixed electrode. In another example, both of the first electrode 11 and the second electrode 12 may be configured as moving electrodes.

From when electricity starts to be applied from the power supply unit 1 to the pair of electrodes 13 and until the applying of electricity stops, the moving electrode (the first electrode 11) is moved along a heating target region of the workpiece w such that the amount of heat is controlled for each of the sub-regions into which the heating target region is virtually divided in a stripe pattern along the electrode moving direction.

In this example, the heating target region is the entire region of the workpiece w, and has a gradually narrowing width along the electrode moving direction. While applying a constant current from the power supply unit 1 to the workpiece w through the pair of electrodes 13, the moving speed of the first electrode 11 is adjusted to control the amount of heat for each of the sub-regions.

The moving mechanism 15 includes an adjusting unit 15a configured to the moving speed of a moving one of the first electrode 11 and the second electrode 12, and a drive mechanism 15b configured to move the moving electrode in accordance with the adjusting unit 15a. The adjusting unit 15a obtains the moving speed of the moving electrode from data on the shape and size of the workpiece w, and the drive mechanism 15b moves the moving electrode at the obtained moving speed. The moving speed which is obtained by the adjusting unit 15a will be described below.

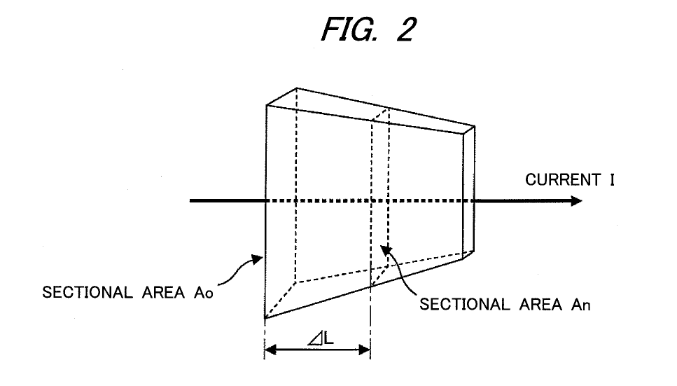

A temperature rise θ₀ as a result of applying a current I for a time period t₀ (sec) to a cross-sectional area A₀ of a unit length as shown in FIG. 2 can be obtained from the following equation:

θ₀(° C.)=ρe/(p·c)×(I²×t₀)/A₀² Equation 1

wherein ρe is resistivity (Ω.m), ρ is a density (kg/m³), and c is specific heat (J/kg.° C.).

A temperature rise θn as a result of applying a current I for a time period tn (sec) to a cross-sectional area An of a unit length can be obtained from the following equation.

θn(° C.)=ρe/(ρ·c)×(I²×tn)/An² Equation 2

Here, assuming that the current I is constant, and the temperature rise θ₀ is equal to the temperature rise θn, the following relation is established.

t₀/A₀²=tn/An² Equation 3

Therefore, a time period to apply a constant current such that different cross sections are heated to the same temperature is proportional to the square of the ratio of cross-sectional areas.

The speed ΔV of the moving electrode may be set as follows:

ΔV=ΔL/(t₀−tn) Equation 4

wherein ΔL is the length of the workpiece w in the longitudinal direction of the workpiece w.

Therefore, the adjusting unit 15a can obtain the moving speed from the data on the shape and size of the workpiece w such as a steel blank, an amount of current supplied from the power supply unit 1, and a target heating temperature.

For example, as shown in FIGS. 1A to 1D, in a case in which the workpiece w has an isosceles trapezoid shape, a constant thickness, and a width varying in the longitudinal direction of the workpiece w, the resistance per unit length changes along one direction, i.e. the longitudinal direction of the workpiece w. In this example, the entire region of the workpiece w is the heating target region. The first electrode 11 and the second electrode 12 are placed such that a space is provided between the first electrode 11 and the second electrode 12 and such that they extend across the heating target region in a direction perpendicular to a direction in which the moving mechanism moves at least one of the first electrode 11 and the second electrode 12, and in a state in which an electric current is being applied from the power supply unit 1, the at least one of the first electrode 11 and the second electrode 12 is moved. For example, the moving speed of the first electrode 11 can be adjusted in accordance with a change in the width of the workpiece w, i.e. a change in the resistance per unit length, along the electrode moving direction, thereby adjusting a time during which an electric current is applied to each part of the heating target region.

By adjusting the electric current applying time in a manner described above, when the workpiece w is virtually divided into sub-regions along the electrode moving direction in a stripe pattern, it is possible to provide an appropriate amount of current commensurate with the resistance to each of the sub-regions, so that the entire heating target region of the workpiece w can be heated to a temperature within a target temperature range.

For example, when the workpiece w has a flat plate shape having a width narrowing toward one end in its longitudinal direction as shown in FIGS. 1A to 1D, the moving speed of the moving electrode is adjusted in accordance with the change of the width of the heating target region of the workpiece w contacting the moving electrode. Based on the foregoing Equation 4, the moving speed is defined by a function proportional to the square of the change rate of cross-sectional area.

The power supply unit 1 may be a direct-current power source or an alternating-current power source. When the power supply unit 1 is an alternating-current power source, an average current in a given period may be maintained constant. In either case, when heating a workpiece w having a varying cross-sectional area, by adjusting the current applying time for each part of the heating target region of the workpiece w, it is possible to keep the temperature rise within the same range in each part of the heating target region of the workpiece w. Each of the electrodes has a size that extends across the heating target region of the workpiece w. That is, each of the electrodes is arranged to extend across the virtually divided stripe-shaped sub-region, so that the same amount of electricity can be provided to each of the stripe-shaped sub-regions to perform uniform heating.

As described above, according to the direct resistance heating apparatus 10, in a case where the width of the workpiece w changes in the longitudinal direction, at least the first electrode 11 of the pair of electrodes 13 is moved, whereby it is possible to uniformly heat the workpiece w. Unlike the related art, it is unnecessary to dispose electrodes at both end portions of the heating target region of the workpiece w facing each other such that the electrodes form a plurality of pairs, and control a supply amount such that an electric current flows regardless of the plurality of pairs of electrodes.

It is also possible to heat the heating target region of the workpiece w by direct resistance heating such that the heating target region has a non-uniform temperature distribution. For example, to heat the heating target region having a constant width along the longitudinal direction by direct resistance heating such that the heating target region has a temperature distribution in which the temperature changes from a high temperature to a low temperature in the longitudinal direction, the moving mechanism 13 simply moves the first electrode 11 while applying an electric current from the power supply unit 1 to the pair of electrodes 13.

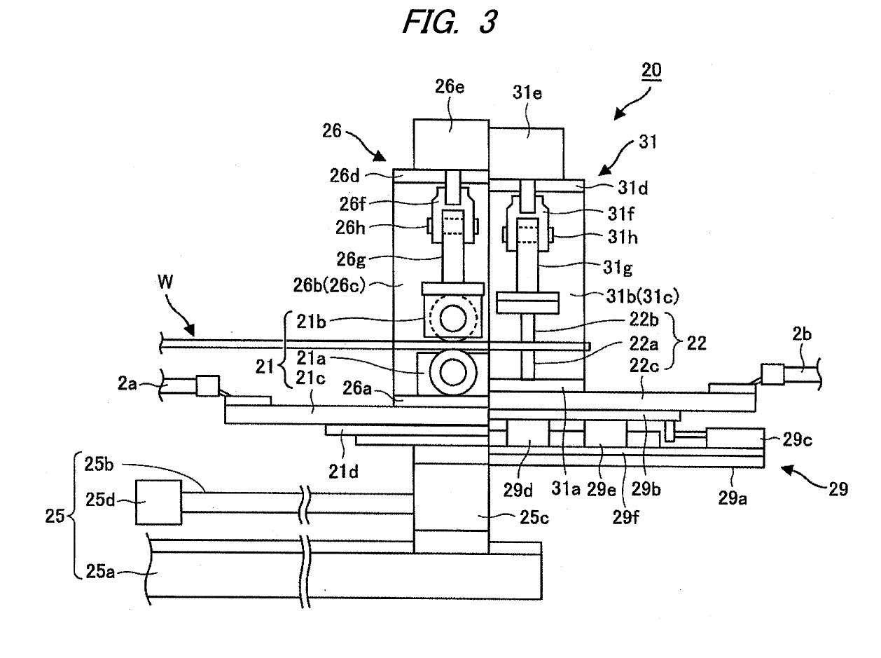

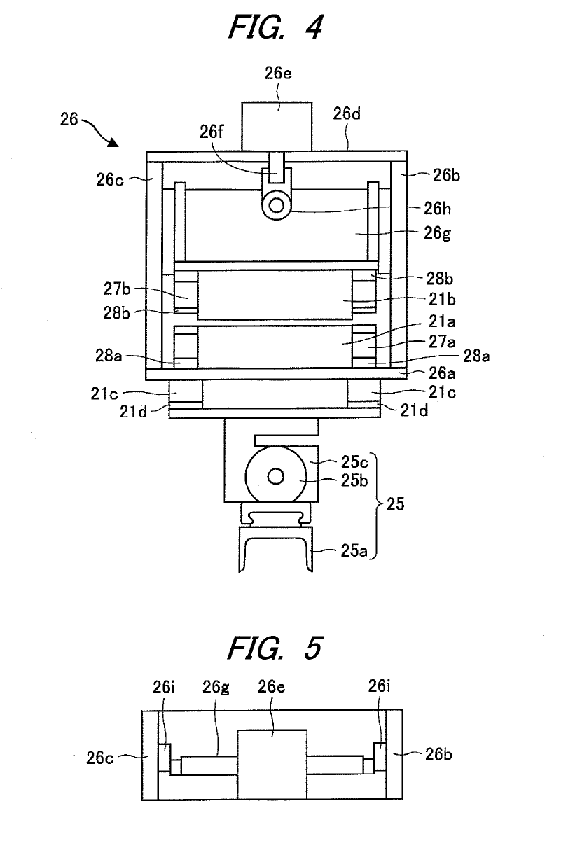

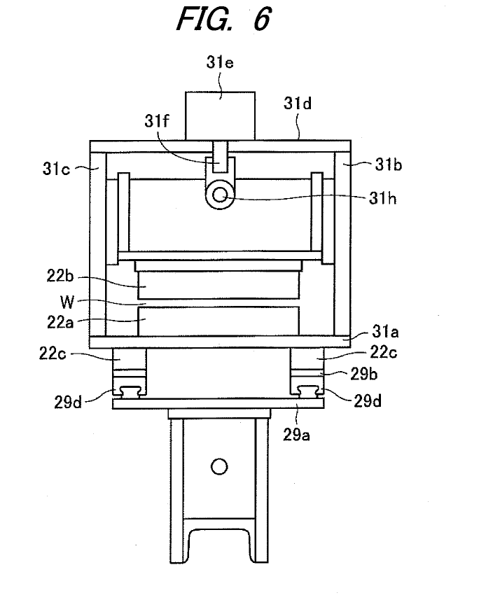

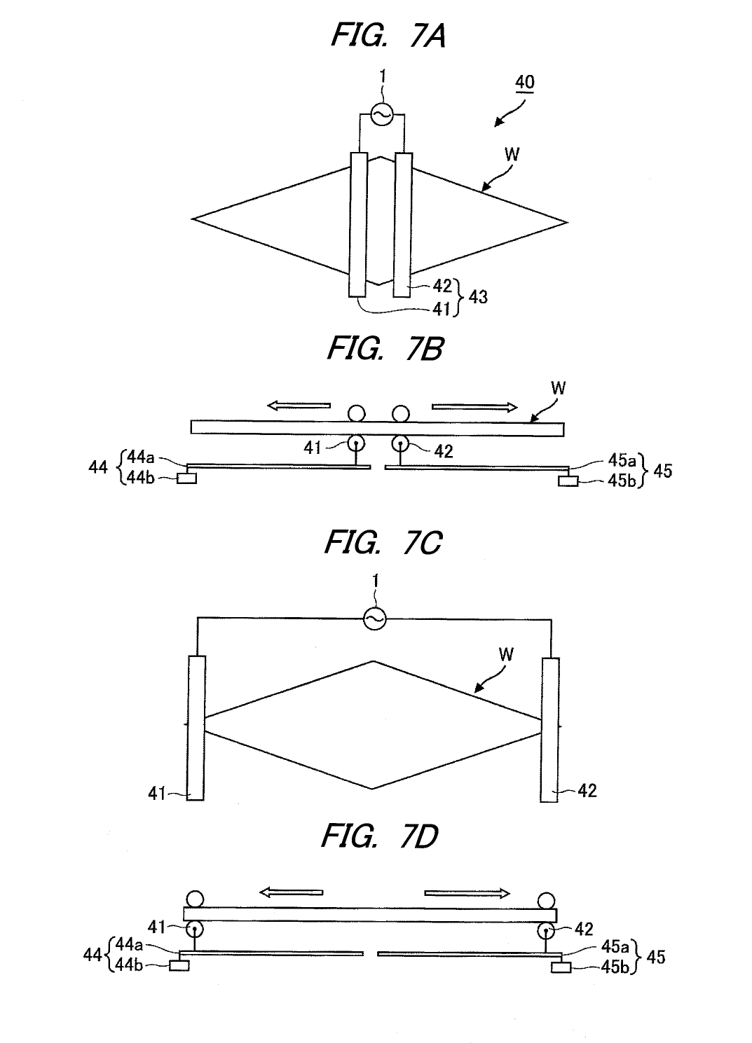

FIGS. 3 to 6 illustrate a direct resistance heating apparatus 20 as an example of a detailed configuration of the direct resistance heating apparatus 10 of FIGS. 1A to 1D. As shown in FIGS. 3 to 6, the direct resistance heating apparatus 20 has a moving electrode 21 and a fixed electrode 22. The electrode 21 has a main electrode portion 21a and an auxiliary electrode portion 21b that are arranged to hold the workpiece w from above and below the workpiece w. The electrode 22 has a main electrode portion 22a and an auxiliary electrode portion 22b that are arranged to hold the workpiece w from above and below the workpiece w.

In FIG. 3, the moving electrode 21 is disposed on the left side, and the fixed electrode 22 is disposed on the right side. The moving electrode 21 has a pair of lead portions 21c, the main electrode portion 21a that contacts the workpiece w, and the auxiliary electrode portion 21b that presses the workpiece w against the main electrode portion 21a. Similarly, the fixed electrode 22 has a pair of lead portions 22c, the main electrode portion 22a that contacts the workpiece w, and the auxiliary electrode portion 22b that presses the workpiece w against the main electrode portion 22a.

As shown in FIG. 3, a moving mechanism 25 includes a guide rail 25a extending in a longitudinal direction, a movement control rod 25b, e.g., a threaded shaft, arranged above the guide rail 25a such that it extends in the longitudinal direction, a slider 25c configured to slide on the guide rail 25a and screwed onto the movement control rod 25b, and a step motor 25d. When the movement control rod 25b is rotated at an adjusted speed by the step motor 25d, the slider 25c moves in the longitudinal direction.

The lead portion 21c is disposed on the slider 25c via an insulating plate 21d. A wiring 2a is electrically coupled to the power supply unit 1, and is fixed to one end portion of the lead portion 21c. The main electrode portion 21a is fixed to the other end portion of the lead portion 21c. The auxiliary electrode portion 21b is attached to a suspending mechanism 26 such that the auxiliary electrode portion 21b is vertically movable.

The suspending mechanism 26 provides a frame having a stage 26a, wall portions 26b, 26c, a bridging portion 26d. More specifically, the suspending mechanism 26 includes the pair of wall portions 26b, 26c provided on one end portion of the stage 26a such that they are separated in the widthwise direction, the bridging portion 26d bridging the upper ends of the wall portions 26b, 26c, a cylinder rod 26e attached to the bridging portion 26d on the axis of the bridging portion 26d, a clamping portion 26f attached to the distal end portion of the cylinder rod 26e, and a holding plate 26g holding the auxiliary electrode portion 21b in an insulated manner. The distal end of the cylinder rod 26e is fixed to the upper end of the clamping portion 26f, and supporting portions 26i are provided on opposing surfaces of the wall portions 26b, 26c, and the holding plate 26g is guided in a state in which the holding plate 26g is movable in a swinging direction around a connecting shaft 26h. In accordance with the vertical movement of the cylinder rod 26e, the clamping portion 26f, the connecting shaft 26h, the holding plate 26g, and the auxiliary electrode portion 21b move vertically. The main electrode portion 21a and the auxiliary electrode portion 21b extend across the heating target region of the workpiece w, and the holding plate 26g can move in the swinging direction around the connecting shaft 26h, so that the entire upper surface of the main electrode portion 21a and the entire lower surface of the auxiliary electrode portion 21b are pressed against the workpiece w.

In order for the main electrode portion 21a and the auxiliary electrode portion 21b to hold the plate-shaped workpiece w in a state in which the main electrode portion 21a and the auxiliary electrode portion 21b both contact the workpiece w while the suspending mechanism 26 and the lead portion 21c are moved in the longitudinal direction by the moving mechanism 25, rotating rollers 27a, 27b are provided for the main electrode portion 21a and the auxiliary electrode portion 21b, respectively, such that they extend across the workpiece w in the widthwise direction of the workpiece w. The rotating roller 27a is rotatably supported by a pair of bearings 28a, and the rotating roller 27b rotatably supported by a pair of bearings 28b. During the movement of the main electrode portion 21a and the auxiliary electrode portion 21b by the moving mechanism 25, an electric current can be continuously applied to the workpiece w through the bearings 28a, 28b and the rotating roller 27a. The moving electrode is provided with means for rolling or sliding on the heating target region of the workpiece while contacting the heating target region, and the rotating rollers 27a, 27b are examples thereof.

On the other side of the direct resistance heating apparatus 20, the fixed electrode 22 is disposed. As shown in FIG. 3, a pulling mechanism 29 is disposed on a stage 29a. The lead portion 22c is disposed on the pulling mechanism 29 via an insulating plate 29b. A wiring 2b is electrically coupled to the power supply unit 1, and is fixed to one end portion of the lead portion 22c. The main electrode portion 22a is fixed to the other end portion of the lead portion 22c. The auxiliary electrode portion 22b is attached to a suspending mechanism 31 such that the auxiliary electrode portion 22b is vertically movable. The suspending mechanism 31 is arranged to cover the main electrode portion 22a.

The pulling mechanism 29 includes a moving means 29c connected to the lower surface of the insulating plate 29b to move the stage 29a in the longitudinal direction, sliders 29d, 29e configured to directly slide the insulating plate 29b in the longitudinal direction, and guide rails 29f arranged to guide the sliders 29d, 29e, and uses the moving means 29c to slide the auxiliary electrode portion 22b, the main electrode portion 22a, and the lead portions 22c in the longitudinal direction, thereby adjusting their positions. Because the direct resistance heating apparatus 20 includes the pulling mechanism 29, even when the workpiece w expands by direct resistance heating, it can be planarized.

The suspending mechanism 31 includes a pair of wall portions 31b, 31c provided in a standing manner at one end portion of a stage 31a such that they are separated in the widthwise direction, a bridging portion 31d bridging the upper ends of the wall portions 31b, 31c, a cylinder rod 31e attached to the bridging portion 31d on the axis of the bridging portion 31d, a clamping portion 31f attached to the distal end portion of the cylinder rod 31e, and a holding plate 31g holding the auxiliary electrode portion 22b in an insulated manner. The holding plate 31g is held by the clamping portion 31f via a connecting shaft 31h. The distal end of the cylinder rod 31e is fixed to the upper end of the clamping portion 31f, and like in the suspending mechanism 26, the holding plate 31g is supported by supporting portions provided on opposing surfaces of the wall portions 31b, 31c such that the holding plate 31g is movable in a swinging direction. In accordance with the vertical movement of the cylinder rod 31e, the clamping portion 31f, the connecting shaft 31h, the holding plate 31g, and the auxiliary electrode portion 22b move vertically. The main electrode portion 22a and the auxiliary electrode portion 22b extend across the heating target region of the workpiece w, and the holding plate 31g can move in the swinging direction around the connecting shaft 31h, so that the entire upper surface of the main electrode portion 22a and the entire lower surface of the auxiliary electrode portion 22b are pressed against the workpiece w.

In a state in which the workpiece w is horizontally supported by horizontally supporting means, the workpiece w is held in a fixed manner between the main electrode portion 22a and the auxiliary electrode portion 22b of the fixing electrode 22, and is also held between the main electrode portion 21a and the auxiliary electrode portion 21b of the moving electrode 21, and then, the moving mechanism 25 moves the moving electrode 21. The moving mechanism 25 moves the moving electrode 21 at a moving speed controlled by the adjusting unit 15a. The adjusting unit 15a adjusts the moving speed of the moving electrode 21 in accordance with the shape of the workpiece w such that the heating target region of the workpiece w is heated uniformly or to have a temperature distribution in which the temperature changes smoothly from a high temperature to a low temperature.

As described above, according to the direct resistance heating apparatus 20, the main electrode portion 21a and the auxiliary electrode portion 21b are disposed to hold the workpiece w from above and below the workpiece w. The solid main electrode portion 21a configured to extend across the heating target region of the workpiece w is arranged to extend across the pair of lead portions 21c (e.g., bus bars) provided along the electrode moving direction. The main electrode portion 21a, the auxiliary electrode portion 21b, and the pair of lead portions 21c are attached to a structure which is moved along the electrode moving direction by the moving mechanism 25. At least one of the main electrode portion 21a and the auxiliary electrode portion 21b is vertically moved by the cylinder rod 26e serving as a pressing means to hold the workpiece w between the main electrode portion 21a and the auxiliary electrode portion 21b, and in this condition, the main electrode portion 21a and the auxiliary electrode portion 21b are moved to run over the workpiece w with an electric current being applied from the main electrode portion 21a to the workpiece w through the bus bars 21c.

The example illustrated in FIGS. 3 to 6 can be modified such that, for example, at least one of the main electrode portion 21a and the auxiliary electrode portion 21b is vertically moved by the cylinder rod 26e to hold the workpiece w between the main electrode portion 21a and the auxiliary electrode portion 21b, and in this condition, the main electrode portion 21a is moved to run over the pair of bus bars with an electric current being applied from the main electrode portion 21a to the workpiece w through the bus bars.

### Second Embodiment

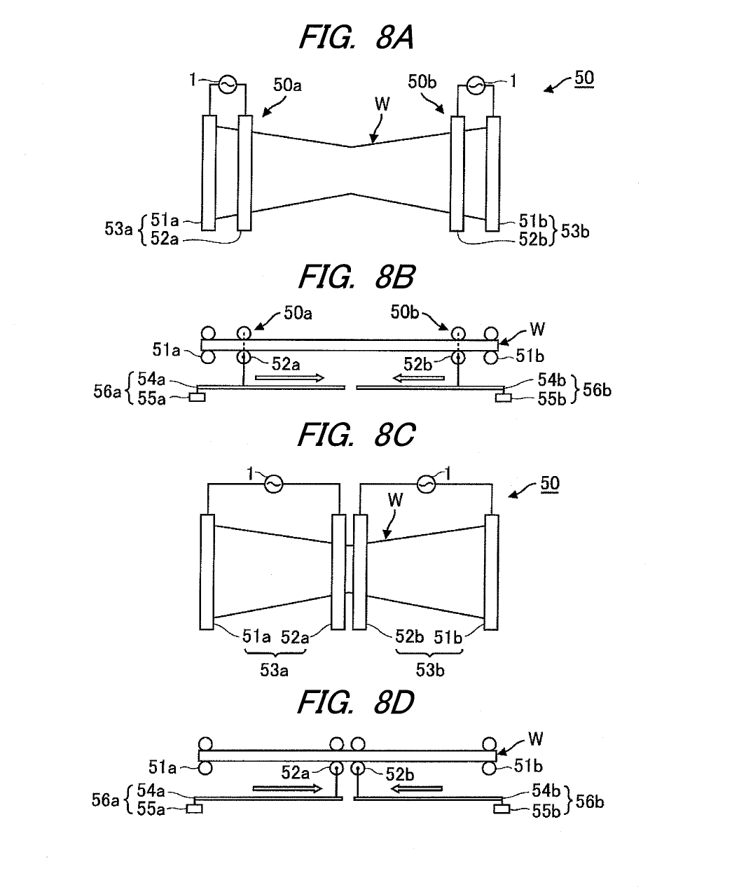

A direct resistance heating apparatus 40 according to a second embodiment of the present invention will be described with reference to FIGS. 7A to 7D.

The direct resistance heating apparatus 40 includes a pair of electrodes 43 electrically coupled to a power supply unit 1 and having a first electrode 41 and a second electrode 42, and moving mechanisms 44, 45 configured to move the first electrode 41 and the second electrode 42, respectively.

With the first electrode 41 and the second electrode 42 both contacting a workpiece w and an electric current being applied from the power supply unit 1 to the workpiece w through the pair of electrodes 43, the moving mechanisms 44, 45 move the first electrode 41 and the second electrode 42 that are disposed so as not to contact each other, respectively, thereby widening the distance between the first electrode 41 and the second electrode 42.

The workpiece w has a rhomboid shape in a plan view, such that the width is the largest at the center position and gradually narrows toward both end portions in the longitudinal direction. To heat this workpiece w uniformly to a temperature within a target temperature range, the first electrode 41 and the second electrode 42 are placed at the center position of the workpiece w such that a small space is provided between the first electrode 41 and the second electrode 42 and such that the first electrode 41 and the second electrode 42 extend across the workpiece w, and the first electrode 41 and the second electrode 42 are moved at the same speed in opposite directions while applying a constant current from the power supply unit 1.

A detailed configuration of the direct resistance heating apparatus 40 may be obtained by providing the moving electrode structure of the first embodiment illustrated on the left side in FIG. 3 on both sides of the direct resistance heating apparatus 40.

### Third Embodiment

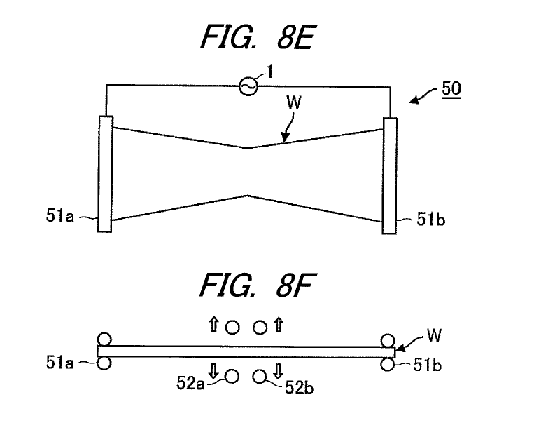

A direct resistance heating apparatus 50 according to a third embodiment of the present invention will be described with reference to FIGS. 8A to 8E.

A workpiece w can be virtually divided into two isosceles trapezoid regions that are symmetric to each other in a plan view. Each of the isosceles trapezoid regions has parallel sides, and long sides of the isosceles trapezoid regions are disposed on the outer side and short sides of the isosceles trapezoid regions are connected to each other. In other words, the workpiece w has a shape similar to a shape obtained by connecting two of the workpiece w as shown in FIG. 1A. In this example, the direct resistance heating apparatus 10 according to the first embodiment may be modified as follows.

The direct resistance heating apparatus 50 includes a current applying unit 50a disposed on one side in the longitudinal direction and another current applying unit 50b disposed on the other side in the longitudinal direction. The current applying unit 50a has a pair of electrodes 53a and a moving mechanism 56a. The current applying unit 50b has a pair of electrodes 53b and a moving mechanism 56b. The pair of electrodes 53a disposed on the left side in a plan view of the workpiece w has a first electrode 51a and a second electrode 52a.

In the current applying unit 50a on the left side, the first electrode 51a is provided at the left end portion of the workpiece w in the plan view as a fixed electrode. The second electrode 52a is provided as a moving electrode on the right side of the first electrode 51a in the plan view with a small space being provided between the first electrode 51a and the second electrode 52a, and is moved by the moving mechanism 56a. In the current applying unit 50b on the right side, the first electrode 51b is provided as a fixed electrode at the right end portion of the workpiece w in the plan view. The second electrode 52b is provided as a moving electrode on the left side of the first electrode 51a in the plan view with a small space being provided between the first electrode 51b and the second electrode 52b, and is moved by the moving mechanism 56b.

Like in the first embodiment and the second embodiment, the moving mechanisms 56a, 56b include adjusting units 54a, 54b configured to control the moving speeds of the moving electrodes, and drive mechanisms 55a, 55b configured to move the moving electrodes in accordance with the adjusting units 54a, 54b. The adjusting units 54a, 54b obtain the moving speeds of the moving electrodes from data on the shape and size of the workpiece w, and the drive mechanisms 55a, 55b move the moving electrodes at the obtained moving speeds.

The electrodes are disposed as shown in FIGS. 8A and 8B, and in a state in which an electric current is being applied from the power supply unit 1 to the workpiece w through the pair of electrodes 53a, 53b, the second electrodes 52a, 52b are moved by the moving mechanisms 56a, 56b such that the second electrodes 52a, 52b move away from the first electrodes 51a and 51b, respectively, as shown in FIGS. 8C and 8D. Then, as shown in FIGS. 8E and 8F, both of the second electrodes 52a, 52b are moved vertically such that the second electrodes 52a, 52b are separated from the workpiece w. The current from the power supply unit 1 to the pair of electrodes 53a, 53b is temporarily stopped, and a switch is used to switch a circuit, an then the power supply unit 1 restarts to apply an electric current between the first electrode 51a and the first electrode 51b. In this way, a portion of the workpiece w between the second electrode 52a and the second electrode 52a can be heated by electric conduction.

Also in the third embodiment, the moving mechanisms 56a, 56b move the second electrodes 52a, 52b serving as moving electrodes at moving speeds controlled based on the shape and size of the workpiece w, an electric current is applied by the pair of electrodes 53a to a portion of the workpiece w between the first electrode 51a and the second electrode 52a, an electric current is applied to by the pair of electrodes 53b to a portion of the workpiece w between the first electrode 51b and the second electrode 52b, whereby the amount of heat is equalized for each part the workpiece w to uniformly heat the workpiece w.

As for the configuration of each of the current applying units 50a and 50b, it is possible to apply the same configuration as that of the first embodiment, and a detailed configuration may be the same as the configuration shown in FIGS. 3 to 6.

### Fourth Embodiment

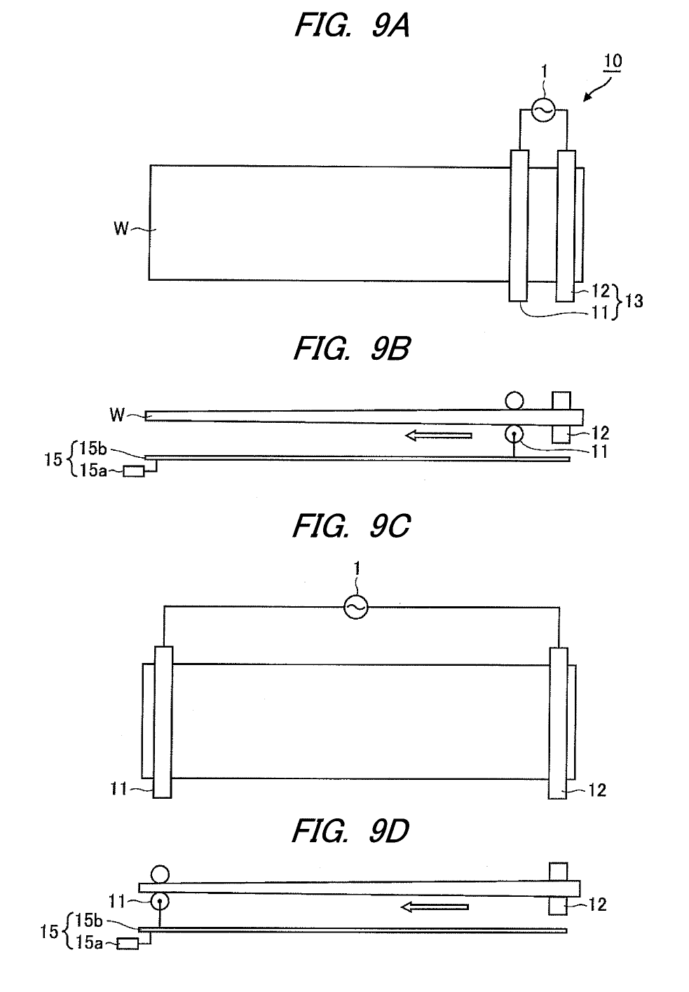

A direct resistance heating apparatus 10 according to a fourth embodiment will be described with reference to FIGS. 9A to 9D.

The configuration of the direct resistance heating apparatus 10 shown in FIG. 9A is the same as that of the direct resistance heating apparatus 10 shown in FIG. 1A. In other words, the direct resistance heating apparatus 10 includes a pair of electrodes 13 electrically coupled to a power supply unit 1 and having a first electrode 11 and a second electrode 12, and a moving mechanism 15 configured to move at least one of the first electrode 11 and the second electrode 12. With the first electrode 11 and the second electrode 12 both contacting a workpiece w and an electric current being applied to the workpiece w through the pair of electrodes 13, the moving mechanism 15 moves the first electrode 11 to change the distance between the first electrode 11 and the second electrode 12.

The fourth embodiment is different from the first embodiment in the shape of the workpiece w. That is, the workpiece w has a constant width along the longitudinal direction in a plan view, but the thickness of the workpiece w is reduced toward one side. Therefore, the cross-sectional area is reduced toward one side.

Also in the fourth embodiment, from when an electric current starts to be applied from the power supply unit 1 to the pair of electrodes 13 to when the applying of the current stops, the moving electrode, e.g., the first electrode 11, is moved. Therefore, it is possible to control the amount of heat for each of the sub-regions into which a heating target region of the workpiece w is virtually divided in a stripe pattern along the electrode moving direction.

Also when the thickness of the workpiece w reduces toward the left side as shown, for example, in FIG. 9B, the moving speed is defined by a function proportional to the square of the change rate of the cross-sectional area, based on the foregoing Equation 4.

### Fifth Embodiment

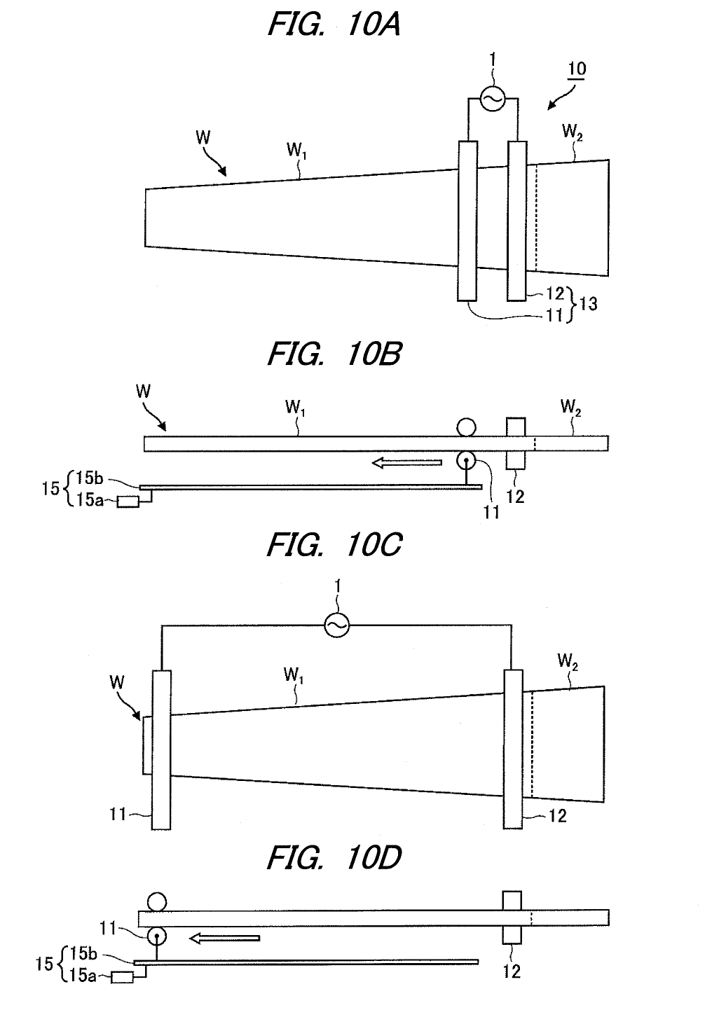

A direct resistance heating apparatus 10 according to the fifth embodiment of the present invention will be described with reference to FIGS. 10A to 10D.

The direct resistance heating apparatus 10 shown in FIG. 10A has the same configuration as that of the direct resistance heating apparatus 10 shown in FIG. 1A. The fifth embodiment is different from the first embodiment in that a heating target region of a workpiece w is not the entire workpiece w but is a region on one side in the longitudinal direction. In other words, the entire region of the workpiece w is divided into two regions, namely, a heating target region w1 and a non-heating region w2. For example, the workpiece w is formed by making a heating target region w1 and a non-heating region w2 from different materials and joining the heating target region w1 and the non-heating region w2 by welding. As an example of use of this type of workpiece w, a member may be configured to absorb an impact by a non-heating region w2 by increasing the hardness of a heating target region w1 and making the non-heating region w2 easily deformed by an impact. In this case, the first electrode 11 and the second electrode 12 are disposed on a side of the heating target region w1 where the cross-sectional area along a direction perpendicular to one direction of the longitudinal direction is larger, and the first electrode 11 is moved in a direction in which the cross-sectional area decreases. The moving speed may be set based on the Equation 4. Accordingly, also in the fifth embodiment, from when an electric current starts to be applied from the power supply unit 1 to the pair of electrodes 13 to when the applying of the current stops, a moving electrode, i.e., the first electrode 11, is moved. Therefore, it is possible to control the amount of heat for each of the sub-regions into which the heating target region w1 of the workpiece w is virtually divided in a stripe pattern along the electrode moving direction.

### Sixth Embodiment

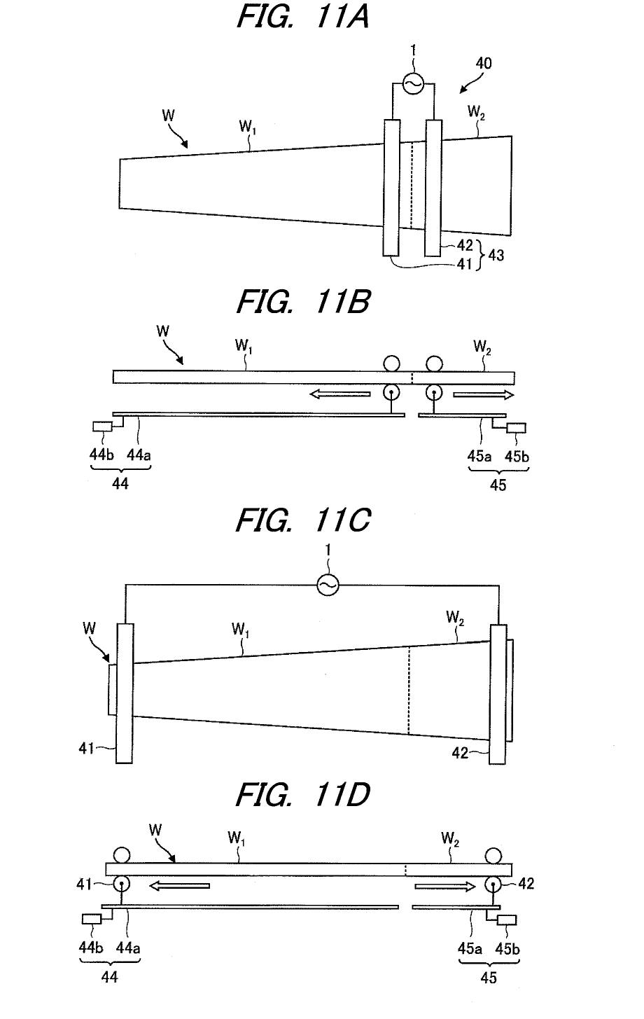

A direct resistance heating apparatus 40 according to a sixth embodiment of the present invention will be described with reference to FIGS. 11A to 11D.

The direct resistance heating apparatus 40 shown in FIG. 11A has the same configuration as that of the direct resistance heating apparatus 40 shown in FIG. 7A. The sixth embodiment is different from the second embodiment in that one side of the workpiece w in the longitudinal direction is a region w1 to be almost uniformly heated to a hot working temperature, and the other side is a region w2 to be uniformly heated to a warm working temperature lower than a quenching temperature. That is, the entire region of the workpiece w has the regions w1, w2 to be heated to different temperatures, respectively. Like in the fifth embodiment, the workpiece w may formed by making the region w1 and the region w2 of different materials, and joining the region w1 and the region w2 by welding. In this example, moving mechanisms 44, 45 move moving electrodes 41, 42 respectively. The left region w1 is uniformly heated to a hot working temperature, whereas the right region w2 is heated to a warm working temperature, such that pressing can be easily performed in the next process. To this end, while a constant current is applied between the moving electrodes 41, 42, the moving mechanism 44 moves the moving electrode 41 such that the relation of Equation 4 is satisfied, whereby the region w1 is uniformly heated to a hot working temperature, and the moving mechanism 45 moves the moving electrode 42 such that the region w2 is heated to a warm working temperature. The movement start timings and the movement stop timings of the moving electrodes 41, 42 may be set in accordance with the sizes of the regions w1 and w2 in the longitudinal direction, the target hot working temperature, and the target warm working temperature.

While the invention has been described with reference to certain embodiments thereof, the scope of the invention is not limited to the embodiments described above, and it will be understood by those skilled in the art that various changes and modifications may be made therein without departing from the scope of the invention as defined by the appended claims.

For example, such changes and modifications may be made in accordance with the shape and size of a workpiece w. The shape of the workpiece w is not limited to those illustrated in the drawings, and as long as a workpiece includes a region where the resistance per unit length decreases due to, for example, a reduction in the cross-sectional area along one direction, the region can be uniformly heated by moving an electrode in the one direction. Also, lateral sides of the workpiece w connecting the respective ends of the workpiece w in the longitudinal direction need not be straight lines, and may be curved, or may be configured by connecting a plurality of straight lines and/or curved lines having different curvatures.

The examples described above includes a case where the entire workpiece w is a heating target region, a case where a portion of the workpiece w is a heating target region, and a case where the workpiece w is divided into a plurality of heating target regions. According to another example, the heating target region may be divided into a plurality of heating target regions in a direction intersecting the moving direction of one of the first electrode and the second electrode that are disposed on the workpiece w with a space provided therebetween, that is, not in the longitudinal direction of the workpiece w but in the widthwise direction of the workpiece w, and the moving electrode may be provided for each of the heating target regions. In this case, the heating target regions may be contiguous in the widthwise direction, or may be separated in the widthwise direction.

As described above, changes and modifications may be made such that one or more moving electrodes are provided to heat the workpiece w by electric conduction in accordance with the shape and size of a workpiece w and a heating target region of the workpiece w, and a use a fixed electrode is optional.

### INDUSTRIAL APPLICABILITY

One or more embodiments of the invention provide a direct resistance heating apparatus and a direct resistance heating method in which an electric current is applied to a workpiece such as a steel blank.

This application is based on Japanese Patent Application Nos. 2011-261076 and 2011-261077, both filed on Nov. 29, 2011, the entire contents of which are incorporated herein by reference.

1. A direct resistance heating apparatus comprising:
a pair of electrodes adapted to be electrically coupled to a power supply unit, the pair of electrodes comprising a first electrode and a second electrode; and
a moving mechanism configured to move at least one of the first electrode and the second electrode to change a distance between the first electrode and the second electrode with the first electrode and the second electrode both contacting a workpiece and with an electric current being applied from the power supply unit to the workpiece through the pair of electrodes.

2. The direct resistance heating apparatus according to claim 1, wherein each of the first electrode and the second electrode has a length extending across a heating target region of the workpiece.

3. The direct resistance heating apparatus according to claim 1, wherein the moving mechanism comprises:
an adjusting unit configured to control a moving speed of the at least one of the first electrode and the second electrode; and
a drive mechanism configured to move the at least one of the first electrode and the second electrode in accordance with the adjusting unit.

4. The direct resistance heating apparatus according to claim 3, wherein the adjusting unit is configured to obtain the moving speed based on shape and size data of the workpiece, and
wherein the drive mechanism moves the at least one of the first electrode and the second electrode at the moving speed obtained by the adjusting unit.

5. The direct resistance heating apparatus according to claim 1, wherein each of the first electrode and the second electrode comprises:
a main electrode portion;
an auxiliary electrode portion; and
a lead portion connected to the power supply unit to apply the electric current to the main electrode portion,
wherein the main electrode portion and the auxiliary electrode portion are arranged to hold the workpiece from above and below the workpiece.

6. The direct resistance heating apparatus according to claim 1, wherein the moving mechanism is configured to move only one of the first electrode and the second electrode.

7. The direct resistance heating apparatus according to claim 1, wherein the moving mechanism is configured to move the first electrode and the second electrode.

8. The direct resistance heating apparatus according to claim 1, wherein the at least one of the first electrode and the second electrode is configured to roll or to slide on the heating target region of the workpiece while contacting the heating target region.

9. A direct resistance heating method comprising:
providing a workpiece having a heating target region, wherein a resistance of the heating target region per unit length in one direction of the heating target region changes along the one direction;
placing a first electrode and a second electrode such that a space is provided between the first electrode and the second electrode and such that each of the first electrode and the second electrode extends across the heating target region; and
moving at least one of the first electrode and the second electrode with an electric current being applied to the heating target region such that a time during which the electric current is applied to each part of the heating target region is adjusted in accordance with a change of the resistance per unit length, thereby heating the workpiece such that the each part of the heating target region is heated to a temperature within a target temperature range.

10. The direct resistance heating method according to claim 9, wherein the electric current applied from a power supply unit to the first electrode and the second electrode is constant.

11. The direct resistance heating method according to claim 9, wherein the heating target region of the workpiece is configured such that a cross-sectional area of the heating target region is reduced in the one direction, and the at least one of the first electrode and the second electrode is moved in accordance with a reduction of the cross-sectional area.
